(19) United States
(12) Patent Application Publication
(10) Pub. No.: US 2017/0241755 A1
(43) Pub. Date: Aug. 24, 2017

(54) SCENT EMITTING DART

(71) Applicants: Donald Bruce Keeney, Evans, WV (US); Donna Keeney, Evans, WV (US)

(72) Inventors: Donald Bruce Keeney, Evans, WV (US); Donna Keeney, Evans, WV (US)

(21) Appl. No.: 15/049,417

(22) Filed: Feb. 22, 2016

(51) Int. Cl. F42B 12/36; A01M 31/00; F42B 6/00; F42B 10/06; F42B 12/46

(52) U.S. Cl. CPC F42B 12/362; F42B 10/06; F42B 12/46; F42B 6/003; A01M 31/008

(57) ABSTRACT

A scent emitting dart for dispersing an olfactant in the target area without having to physically enter the target area includes an elongated, textured shaft member that has a proximal end and a distal end, a tip member which includes a weighted portion and a tip portion integral with the distal end, and a scent carrying fletching integral having a plurality of absorbent vanes adjacent to the proximal end. The absorbent vanes both extend outwardly from the circumference of the shaft member to provide aerodynamic stabilization and also extend behind the shaft member to both increase the olfactant absorption capacity of the fletching and provide an accessible point of concentration for applied olfactant. In this regard, as the olfactant is emitted from the fletching, a hunted animal can be drawn thereto.

### BACKGROUND OF THE INVENTION

Field of the Invention

This invention relates generally to hunting accessories and, more particularly, to a throwable dart which emits olfactant so as to allow remote scent dispensing from a hidden location.

Description of the Prior Art

The practice of spreading olfactant while hunting game such as deer is well established. A problem which still exists, however, is that if a hunter's own scent is spread in the area where a hunter is attempting to lure a deer, the hunter's scent will general cause a deer to abandon an area immediately despite the olfactant. Thus, there remains a need for a scent emitting dart which would eliminate the need for a user to actually enter a target area in order to disperse olfactant in the target area. It would be helpful if such a scent emitting dart included a fabric fletching which allowed a user to apply a selected olfactant right before use. It would be additionally desirable for such a scent emitting dart to include an elongated body which allows it to be grasped and projected by hand so as to not require additional parts to project it to a desired location.

The Applicant's invention described herein provides for a scent emitting dart adapted to allow a user to project olfactant dispersing material to a remote target location from a hidden position. The primary components in Applicant's scent emitting dart are a tip, a shaft and scent carrying fletching. When in operation, the scent emitting dart enables olfactant to be dispersed in a target location by a user without the user's scent contaminating the target area. As a result, many of the limitations imposed by prior art structures are removed.

### SUMMARY OF THE INVENTION

A scent emitting dart for dispersing an olfactant in the target area without having to physically enter the target area. The scent emitting dart comprises an elongated, textured shaft member that has a proximal end and a distal end, a tip member which includes a weighted portion and a tip portion integral with the distal end, and a scent carrying fletching integral having a plurality of absorbent vanes adjacent to the proximal end. The absorbent vanes both extend outwardly from the circumference of the shaft member to provide aerodynamic stabilization and also extend behind the shaft member to both increase the olfactant absorption capacity of the fletching and provide an accessible point of concentration for applied olfactant. In this regard, as the olfactant is emitted from the fletching, a hunted animal can be drawn thereto.

It is an object of this invention to provide a scent emitting dart which would eliminate the need for a user to actually enter a target area in order to disperse olfactant in the target area.

It is another object of this invention to provide a scent emitting dart which includes a fabric fletching which allowed a user to apply a selected olfactant right before use.

It is yet another object of this invention to provide a scent emitting dart which includes an elongated body which allows it to be grasped and projected by hand so as to not require additional parts to project it to a desired location.

These and other objects will be apparent to one of skill in the art.

### BRIEF DESCRIPTION OF THE DRAWINGS

FIG. 1 is a side elevational view of a scent emitting dart built in accordance with the present invention.

FIG. 2 is a rear elevational view of a scent emitting dart built in accordance with the present invention.

FIG. 3 is a front elevational view of a scent emitting dart built in accordance with the present invention.

### DETAILED DESCRIPTION OF THE INVENTION

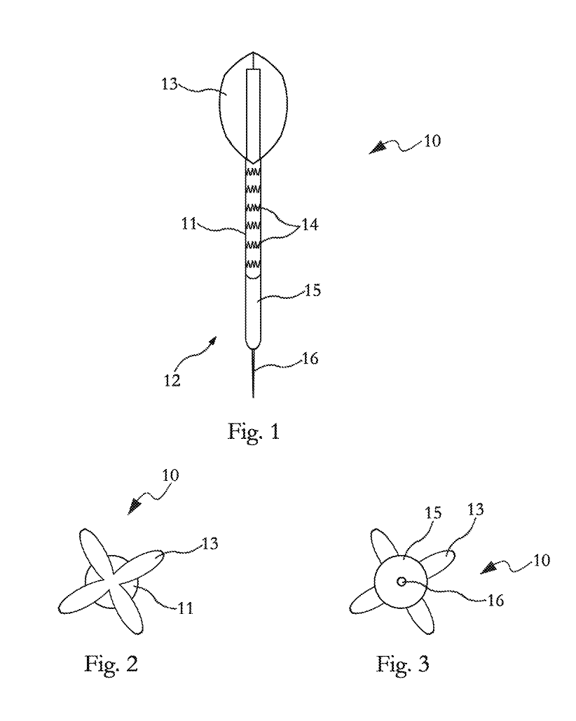

Referring now to the drawings and in particular FIGS. 1, 2, and 3, a scent emitting dart 10 is shown having a shaft member 11 that has a proximal end and a distal end, with a tip member 12 integral with the distal end and a scent carrying fletching 13 integral with the proximal end. The shaft member 11 defines in the preferred embodiment an elongated dowel having a plurality of grooves 14 in its surface. As the scent emitting dart 10 is intended to be thrown by hand, it is contemplated that the plurality of grooves 14 give the shaft member 11 a textured surface which makes it easier for a user to grip (particularly as a user may desire to wear gloves so as to not apply their own scent to the scent emitting dart 10). In the preferred embodiment, the shaft member 11 is constructed of a rigid plastic or wood.

The tip member 12 includes a weighted portion 15 and a tip portion 16. The weighted portion 15, is constructed of a relatively dense metal, such as silver-nickel or a tungsten alloy (between 80 and 95 percent tungsten, to decrease the brittle nature of the tungsten). It is contemplated that distal end is permanently attached to the weighted portion 15. The tip portion 16 defines a tapering member with a pointed end and, in the preferred embodiment, is constructed of steel.

In the preferred embodiment, the fletching 13 includes four (4) vanes which extend from the shaft member 11 at various locations around its perimeter and extend beyond the proximal end of the shaft member 11 to connect with one another behind the shaft member 11. The defines fletching 13 is constructed of a fabric material which can absorb a liquid containing an olfactant. In the preferred embodiment, the fletching 13 is constructed of felt.

In use, a user can spray the fletching 13 with an liquid olfactant and then throw the scent emitting dart 10 towards a target area. Ideally, the tip member 12 of the scent emitting dart 10 will contact and stick into a ground surface, with the fletching 13 sticking up from the ground surface. From this position, the olfactant emits from the fletching 13 so as to attract the animal being hunted. Accordingly, a user can disperse the olfactant in the target area by merely throwing a scent emitting dart 10 which has been sprayed with such an olfactant into the vicinity—without having to physically enter the target area.

In the preferred embodiment, the scent emitting dart 10 measures five (5) inches.

In one embodiment, the shaft member 11 defines an elongated flexible body as opposed to a rigid dowel.

The instant invention has been shown and described herein in what is considered to be the most practical and preferred embodiment. It is recognized, however, that departures may be made therefrom within the scope of the invention and that obvious modifications will occur to a person skilled in the art.

1. A scent emitting dart adapted to be thrown by hand, comprising:
a shaft member defining an elongated body and having a proximal end and a distal end;
a tip member integral with the distal end, wherein said tip member includes at least a tip portion defining a tapering member with a pointed end; and
a fletching integral with the proximal end, wherein said fletching includes a four vanes extending from the shaft member and extending beyond the length of the shaft member, connecting to each other, forming a point beyond the length of the shaft member, wherein said and adapted to absorb a scented fluid material.

2. (canceled)

3. (canceled)

4. The scent emitting dart of claim 1, wherein said tip member additionally includes a weighted portion positioned between the shaft member and the tip portion.

5. The scent emitting dart of claim 4, wherein said weighted portion is cylindrical.

6. The scent emitting dart of claim 5, wherein said shaft member is cylindrical.

7. The scent emitting dart of claim 1, wherein said shaft member defines an elongated dowel.

8. The scent emitting dart of claim 1, wherein said shaft member is cylindrical.

9. A scent emitting dart, adapted to be thrown by hand, comprising:
a cylindrical shaft member defining an elongated body and having a proximal end and a distal end;
a tip member integral with the distal end, wherein said tip member includes a tip portion defining a tapering member with a pointed end and a cylindrical weighted portion positioned between the shaft member and the tip portion; and
a fletching integral with the proximal end and adapted to absorb a scented fluid material, wherein said fletching includes a plurality of vanes which are attached to the shaft member and which connect with one another and form a point beyond the length of the shaft member.

10. The scent emitting dart of claim 9, wherein said fletching includes a four vanes.
